(19) United States
(12) Patent Application Publication
(10) Pub. No.: US 2005/0162569 A1
(43) Pub. Date: Jul. 28, 2005

(54) Television remote control system and method with alphanumeric input

(75) Inventors: Jon Arthur Fairhurst, Camas, WA (US); Henry Y. Fang, Cerritos, CA (US); Bryan Severt Hallberg, Vancouver, WA (US); Mark Gregory Hanley, Skamania, WA (US); Vishnu Kumar Shivaj Rao, (US); Jeffrey B. Sampsell, San Francisco, CA (US)

Correspondence Address: MARGER JOHNSON & MCCOLLOM, P.C. - SHARP, 1030 SW MORRISON STREET, PORTLAND, OR, 97205, US

(73) Assignee: Sharp Laboratories of America, Inc., Camas, WA (US)

(21) Appl. No.: 10/753,934

(22) Filed: Jan. 6, 2004

(51) Int. Cl. H04N 5/44

(52) U.S. Cl. 348/734

(57) ABSTRACT

The invention relates to an improved television remote control system and method with alphanumeric keyboard input. The alphanumeric keyboard input might be used in interactive televisions to control applications and functions. The remote control includes alphanumeric and controls keyboards, an encoder to encode the alphanumeric and control keyboards with alphanumeric and control codes, respectively, and a transmitter to transmit the alphanumeric and control codes to the television.

### FIELD OF THE INVENTION

This invention relates generally to a television remote control and, more particularly, to a television remote control system and method with alphanumeric input.

### BACKGROUND OF THE INVENTION

Many televisions have associated remote controls. A viewer actuates keys or buttons on the remote to control various television settings. For example, a viewer might actuate power, channel, volume, and mute keys to control a television's power, channel, volume, and mute settings, respectively. The remote might additionally include numeric keys (e.g., 0-9 buttons) for directly inputting specific channels and navigation buttons (e.g., up, down, left, right, and select) for controlling menus displayed on the television. And the remote control might include miscellaneous buttons (e.g., play, pause, rewind, fast forward, and rewind) for controlling devices external to the television, e.g., video cassette players and recorders, satellite receivers, digital video disk players, compact disk players, and the like.

Interactive televisions often contain a wide variety of simultaneously executing applications as well as displaying broadcast content. For example, interactive televisions allow the display of broadcast content on one window while simultaneously executing an application running in another window. Typical remote controls are adequate for controlling common television functions, such as the functions we describe above, but are often inadequate for the additional advanced functions associated with interactive televisions.

Many interactive televisions run applications that require alphanumeric input, such as would be available on a personal computer executing the same applications. While remote controls often include numeric keys (e.g., 0-9 buttons) for the direct entry of specific channels as we describe above, they do not include alphabetic, punctuation, space, and other special characters often necessary to control advanced applications and/or functions on an interactive television. For example, alphanumeric input might be necessary to run a word processing or search application running on an interactive television.

Prior interactive televisions include soft keyboards that graphically display an alphanumeric keyboard on the television screen. The viewer uses navigation buttons (e.g.., up, down, left, right, and select) to traverse the soft keyboard and select the desired letter or character. Soft keyboards are inefficient and time consuming because several keystrokes are necessary to actuate a single letter.

Other interactive televisions implement telephone-style input by associating a single remote control key to a group of alphabetic letters, the first letter being actuated by a single press of the key, the second letter being actuated by a second press of the key, the third letter being actuated by the third press of the key, and so on. For example, the letters “a,” “b,” and “c” are associated with a particular key, e.g., the number 2. A single press of the number 2 key selects the letter “a” while two presses selects the letter “b” and three presses selects the letter “c.” As with soft keyboards, telephone-style input is inefficient and time consuming because several keystrokes are necessary to actuate a single letter.

Accordingly, a need remains for an improved television system and method with alphanumeric input.

### BRIEF DESCRIPTION OF THE DRAWINGS

The foregoing and other objects, features, and advantages of the invention(s) will become more readily apparent from the detailed description of invention embodiments that references the following drawings.

FIG. 1 is a diagram of a television system embodiment.

FIG. 2 is a diagram of a remote control embodiment.

FIGS. 3A and 3B are diagrams of a remote control embodiment.

FIG. 4 is a diagram of a remote control embodiment.

FIG. 5 is a diagram of a remote control embodiment.

FIG. 6 is a diagram of a transmitter embodiment.

FIG. 7 is a block diagram of a remote control embodiment.

FIG. 8 is a block diagram of a television embodiment.

### DESCRIPTION OF THE INVENTION

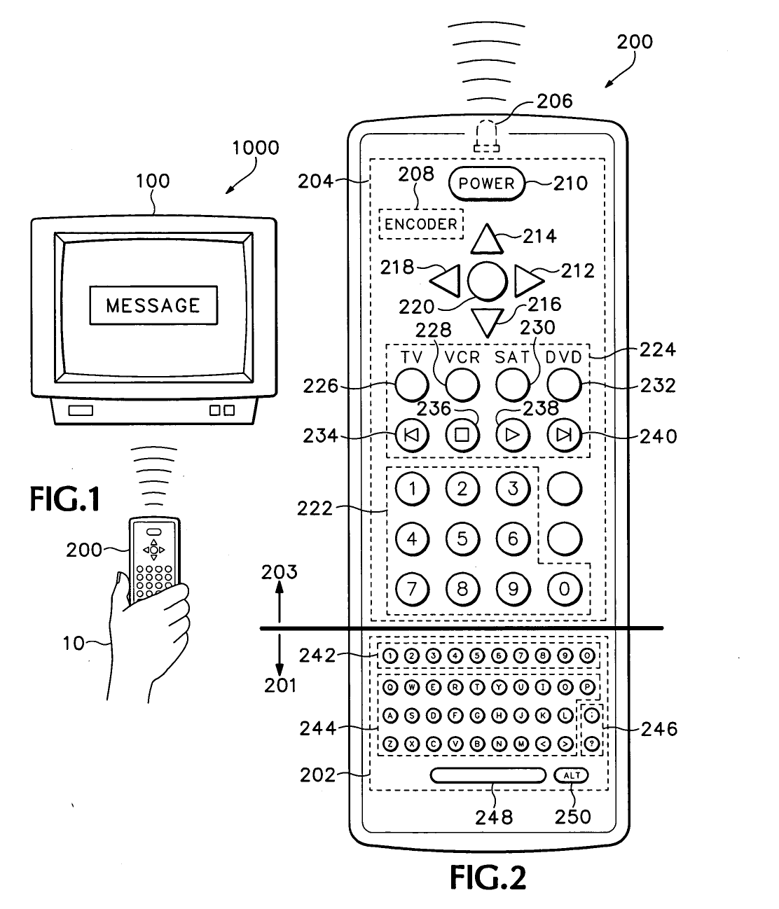

FIG. 1 is a diagram of a television system embodiment 1000. A viewer 10 remotely controls a television 100 using a remote 200. The viewer 10 controls the television 100 by actuating or pressing keys or buttons on the remote 200. The remote 200, in turn, encodes the key or button presses and transmits these key codes to the television 100. The television 100, in turn, receives, decodes, and operates responsive to the key codes. A person of reasonable skill in the art should recognize that the remote 200 might encode the key presses in a variety of well-known manners, including using binary schemes. Additionally, a person of reasonable skill in the art should recognize that the remote 200 might transmit the key codes to the television 100 using a variety of mechanisms, e.g., infrared and radio wave technologies. The remote 200 includes an alphanumeric keypad as best shown in FIGS. 2-5. It should be apparent to a person of skill in the art that the alphanumeric keypad might include numeric, alphabetic, punctuation, space, and/or special character keys.

FIG. 2 is a diagram of a remote control embodiment 200. Referring to FIGS. 1, 2, and 7, the remote 200 includes a top portion 203 and a bottom portion 201 positioned below the top portion 203 in a longitudinal direction. The top portion 203 includes a plurality of control keys 204 used by the viewer 10 to operate the television 100. The plurality of control keys 204 is generally aligned in a longitudinal direction for easy identification by the viewer 10.

The plurality of control keys 204 might comprise a power key 210 to turn the television on and off and a plurality of navigational keys including up key 214, down key 216, right key 212, left key 218, and select key 220. The plurality of control keys 204 might further comprise a plurality of numeric keys 222 that include the numerals 0-9.

The plurality of control keys 204 might further comprise external device control keys 224 used by the viewer 10 to control devices (not shown) external to the television, e.g., video cassette players and recorders, satellite receivers, digital video disk players, compact disk players, and the like. The external device control keys 224 might include keys 226-232 that the viewer 10 actuates to identify the device that is to be controlled by the remote 200, including television (TV) key 226, video cassette recorder (VCR) key 228, satellite (SAT) key 230, and digital video disk (DVD) player key 232. A person of reasonable skill in the art should understand that external devices other than the ones listed might be controlled with the remote 200 using dedicated external device control keys such as VCR key 228, SAT key 230, DVD key 232, and the like. The external device control keys 224 might further include reverse key 234, stop key 236, play key 238, and forward key 240. A person of reasonable skill in the art should understand that control keys 204 other than the ones shown might be necessary to control external devices associated with the television 100.

The bottom portion 201 includes a plurality of alphanumeric keys 202 also used by the viewer to operate the television 100. More particularly, the alphanumeric input is often necessary to operate applications and functions associated with interactive televisions. These applications might include Java language applications available to the television 100 via an associated personal computer (not shown) or a removable media card (not shown) inserted into the television 100. For example, a word processing application (not shown) might be launched on the television 100 that requires alphanumeric input to create document and other like files. For another example, a searching application (not shown) might be launched on the television 100 that requires alphanumeric input to identify a search term. A person of reasonable skill in the art should recognize applications in languages other than Java that might necessitate alphanumeric input. A person of reasonable skill should recognize other mechanisms to make available the applications to the television 100 other than the personal computer or removable media card we mention above.

The plurality of alphanumeric keys 202 might include alphabetic keys 244, numeric keys 242, punctuation keys 246, space key 248, and special character keys (e.g., ALT key 250). The plurality of alphanumeric keys 202 might be arranged in a QWERTY fashion. The remote 200 includes an encoder 208 and a transmitter 206 shown in FIG. 7. Referring to FIGS. 1-2 and 7, the viewer 10 actuates any of the control or alphanumeric keys 202 and/or 204, respectively, by e.g., pressing the desired key. An encoder 208 encodes the plurality of control keys 202 with a corresponding plurality of control codes 254. The encoder 208 provides the control codes 254 to the transmitter 206 responsive to the viewer 10's key actuation. Similarly, the encoder 208 encodes the plurality of alphanumeric keys 202 with a corresponding plurality of alphanumeric codes 252. The encoder 208 provides the alphanumeric codes 252 to the transmitter 206 responsive to the viewer 10's key actuation. The encoder generates the control and alphanumeric codes 254 and 252 from the control and alphanumeric keys 202 and 204, respectively, using a variety of well-known encoding mechanisms, e.g., binary encoding mechanisms. Binary encoding mechanisms include assigning a series of binary codes to certain key presses. For example, the Power key might be assigned the number “0” while the Channel Up key is assigned the number 1, and so on. The encoder 208 might encode these codes into serial streams for transmission by the transmitter 206. If the key press message includes six bits, e.g., “100010,” then a maximum of 64 unique keys might be coded on the remote control. The encoding of the numbers assigned to each key might be accomplished using a straight binary assignment, e.g., 1 is binary “000001”, 2 is binary “000010”, and so on. A person of reasonable skill in the art should recognize other that more or fewer bits can be used depending on the application. A person of reasonable skill in the art should recognize other encoding mechanisms come within the scope of the present invention. The encoder 208's design will not be discussed in any further detail. It should be apparent to a person of skill in the art that the control codes 254 might be different or the same as the alphanumeric codes 252 as we explain in more detail below.

The transmitter 206, in turn, transmits the control codes 252 or the alphanumeric codes 254 to the television 100. The transmitter 206 transmits the codes 252 and 254 using any of a variety of well known transmitting technologies, e.g., infrared and radio wave technology. The transmitter 206 uses a signaling protocol to transmit the codes 252 and 254. For example, the transmitter 206 might use a serial binary scheme, i.e., a stream of ones and zeros, to communicate with the television 100. Certain binary patterns might be reserved to indicate that a new message is ready to be sent. After a code (e.g., codes 252 and/or 254) are transmitted, other bits might follow that indicate error detection or correction or transmission completion. The transmission signaling method used by the transmitter 206 might vary in ways well known to those skill in the art and will not be explained in any further detail.

The transmitter 206 might include one or several transmitting devices oriented in one or more directions. In the remote 200 shown in FIG. 2, the transmitter 206 is a single transmitting device that uses, e.g., infrared light emitting diodes (LEDs) to transmit the codes 252 and 254 to the television 100. In the remote 200 shown in FIG. 2, the control codes 200 are distinct from the alphanumeric codes 254 since both the control keys 204 and the alphanumeric keys 202 are positioned in a longitudinal direction and a single transmitter 206 transmits both the control and alphanumeric codes 252 and 254.

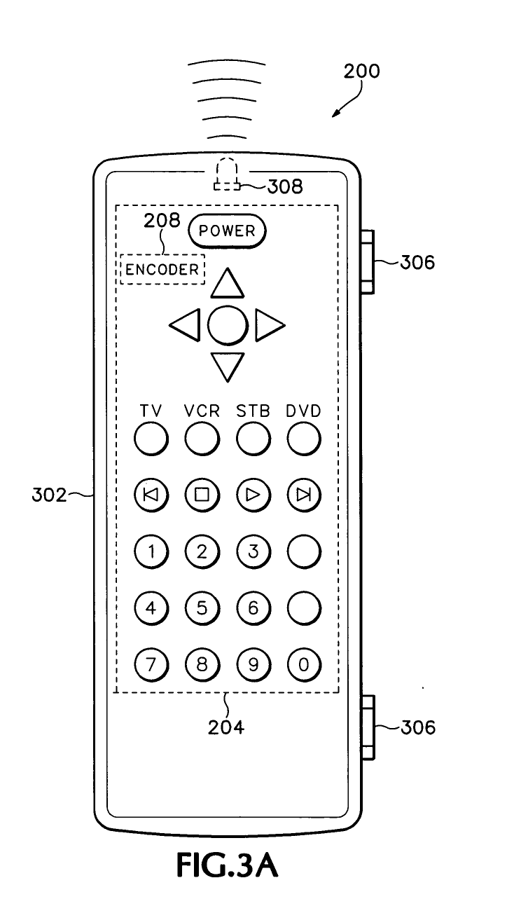

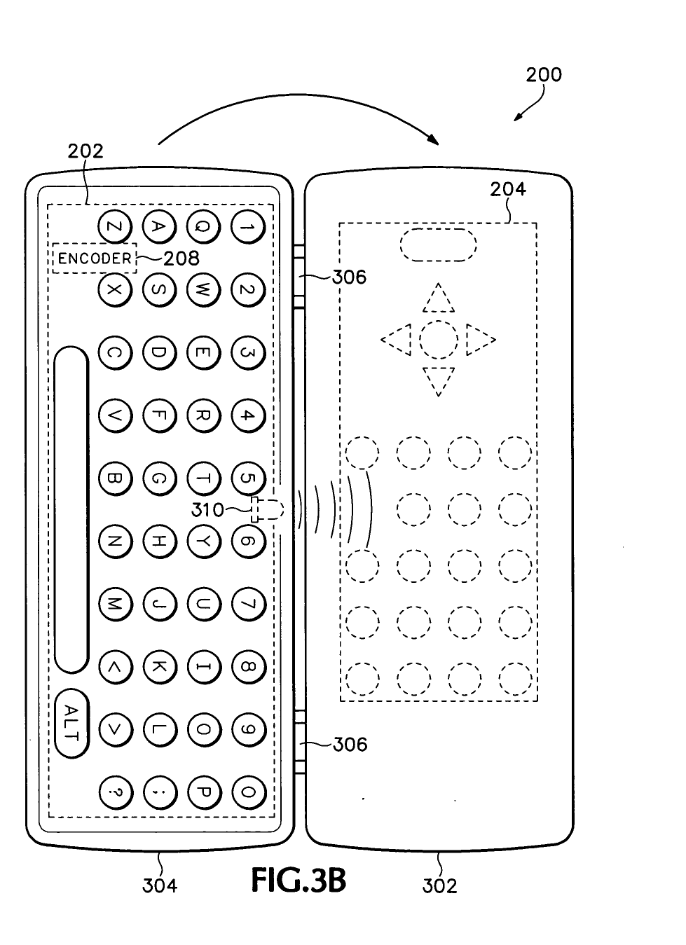

FIGS. 3A and 3B are diagrams of an alternative remote control embodiment 200. Referring to FIGS. 1, 3A-3B, and 7, the remote 200 includes a top portion 302 movably coupled to a bottom or body portion 304 FIG. 3B. The top portion 302 might be movably coupled to the bottom portion 304 using any of a number of well-known mechanisms, e.g., hinges 306. A person of reasonable skill in the art should recognize other mechanisms suitable for movably coupling the top portion 302 to the bottom portion 304.

The control keys 204 might be located on the top portion 302 (FIG. 3A) aligned in first direction, e.g., along a longitudinal direction. The alphanumeric keys 202, in turn, might be located on the bottom portion 304 (FIG. 3B) and aligned in a second direction, e.g., a direction transverse to the longitudinal direction. That is, where the first direction is substantially orthogonal to the second direction. A person of reasonable skill in the art should recognize that the positioning of the control keys 204 and the alphanumeric keys 202 might be switched or aligned along a same direction, longitudinal or otherwise.

The viewer 10 opens or flips the top portion 302 on the hinges 306 to expose the alphanumeric keys 202 on the bottom portion 304. Since the alphanumeric keys 202 are aligned in a second direction, the viewer will typically rotate the remote 200 to the second direction when it wishes to actuate the alphanumeric keys 202. For example, the viewer 10 will rotate the remote by 90 degrees when the alphanumeric keys 202 are aligned substantially orthogonal to the control keys 204.

The remote 200 includes the encoder 208 and the transmitter 206 shown in FIG. 7. In the embodiment shown in FIGS. 3A and 3B, the transmitter 206 includes first and second transmitting devices 308 and 310, respectively. The first and second transmitting devices 308 and 310 might use any of a variety of well known transmitting technologies, e.g., infrared and radio waves. The first and second transmitting devices 308 and 310 might be oriented in one or several directions. In the remote 200 shown in FIGS. 3A and 3B, the first transmitting device 308 is oriented in the first direction while the second transmitting device 310 is oriented in the second direction. The first direction might be substantially orthogonal to the second direction.

In an embodiment, the first and second transmitting devices 308 and 310 are infrared LEDs. The first and second infrared LEDs 308 and 310 might be oriented in the first and second directions, e.g., substantially orthogonal to each other.

In another embodiment, the first and second transmitting devices 308 and 310 are directional antennas that transmit the control and alphanumeric codes 254 and 252 via radio waves. The directional antennas 308 and 310 might be aligned in the first and second directions, e.g., substantially orthogonal to each other. By so orienting the first and second directional antennas 308 and 310, one or the other antenna sends a stronger signal to the television 100 depending on the remote 200's orientation. For example, the first directional antenna 308 will send a stronger signal to the television 100 (relative to the second directional antenna 310) when the remote is aligned in the first direction while the second directional antenna 310 will send a stronger signal the to the television 100 (relative to the first directional antenna 308) when the remote is aligned in the second direction.

The first directional antenna 308 might transmit using a first frequency carrier signal while the second directional antenna 310 might transmit using a second frequency carrier signal. The first carrier signal might be the same or different from the second frequency carrier signal. Where the first carrier signal is the same as the second carrier signal, the encoder 208 encodes the control keys 204 with unique control codes 254, different than the alphanumeric codes 252 it encodes the alphanumeric keys 202. Doing so allows the television 100 to distinguish whether the viewer 10 has pressed an alphanumeric key 202 or a control key 204.

The first transmitting device 308 might transmit the control codes 254 while the second transmitting device transmits the alphanumeric codes 252. In an embodiment, the first transmitting device 308 might transmit the control codes 254 while oriented in the first direction while the second transmitting device 310 might transmit the alphanumeric codes 252 while oriented in the second direction.

In another embodiment, a single multidirectional or omni directional antenna might be used in place of the first and second directional antennas. That is, a single antenna that operates well in both the first and second directions replaces the first and second directional antennas.

Alternatively, the first and second transmitting devices 308 and 310 might transmit responsive to whether the top portion 302 is open. For example, the first transmitting device 308 might only transmit control codes 254 when the top portion 302 is closed while the second transmitting device 310 might only transmit alphanumeric codes 252 when the top portion 302 is open. Such a configuration allows the encoder 208 to encode the control keys 204 with the same codes as it uses to encode the alphanumeric keys 202. Put differently, the encoder 206 might encode a control key 204 with the same code as it uses for an alphanumeric key 202 since the television 100 can differentiate them by identifying from which transmitter it receives the codes.

Alternatively, only a single transmitter 206 is necessary if the remote 200 detects the top portion 302 is open.

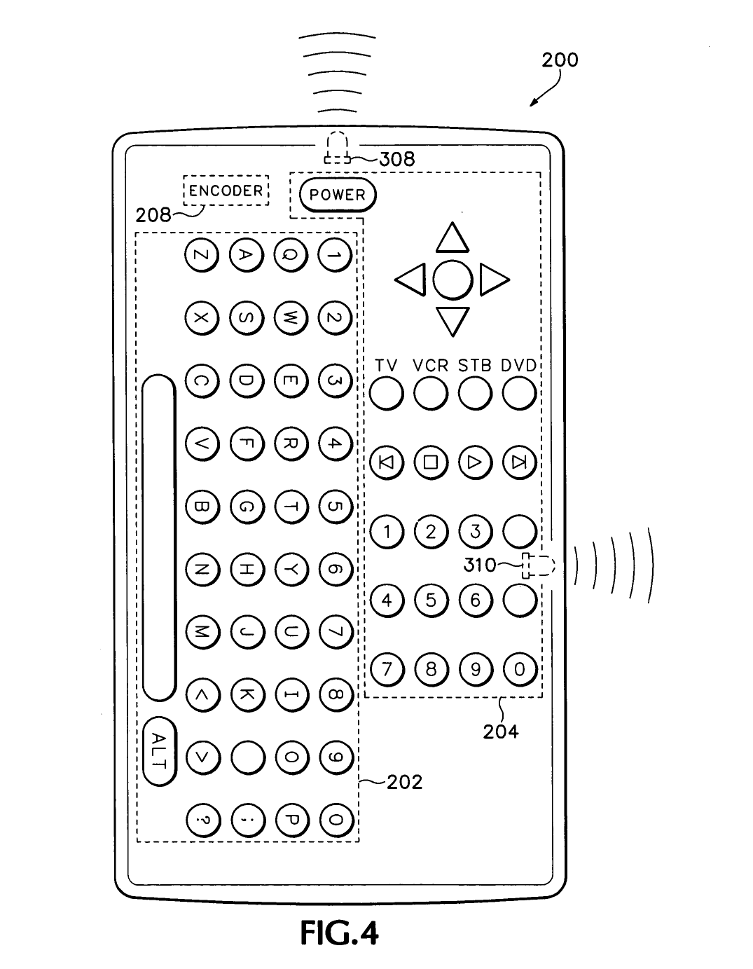

FIG. 4 is a diagram of an alternative remote control embodiment 200. Referring to FIGS. 1, 4, and 7, the remote 200 includes the plurality of control keys 204 located alongside the plurality of alphanumeric keys 202. The plurality of control keys 204 is aligned in the first direction, e.g., in a longitudinal direction. The plurality of alphanumeric keys 202 is aligned in a second direction, e.g., substantially orthogonal to the first longitudinal direction.

The remote 200 includes first and second transmitting devices 308 and 310. We explained the operation of the first and second transmitting devices 308 and 310 above with reference to FIGS. 3A and 3B.

The viewer 10 positions the remote 200 in the first direction when he actuates the control keys 204. The encoder 206 encodes the control keys 204 with control codes 254 that it provides to the first transmitting device 308. The first transmitting device 308, in turn, transmits the control codes 254 to the television 100.

The viewer 10 rotates the remote 200 to the second direction (e.g., substantially orthogonal to the first direction) when he actuates the alphanumeric keys 202. The encoder 206 encodes the alphanumeric keys 202 with alphanumeric codes 252 that it provides to the second transmitting device 310. The second transmitting device 310, in turn, transmits the control codes to the television 100. As with previous embodiments, the control codes 254 might be the same or different than the alphanumeric codes 252. The television 100 might be capable of distinguishing a same code as being an alphanumeric code 252 by identifying the second transmitting device 310.

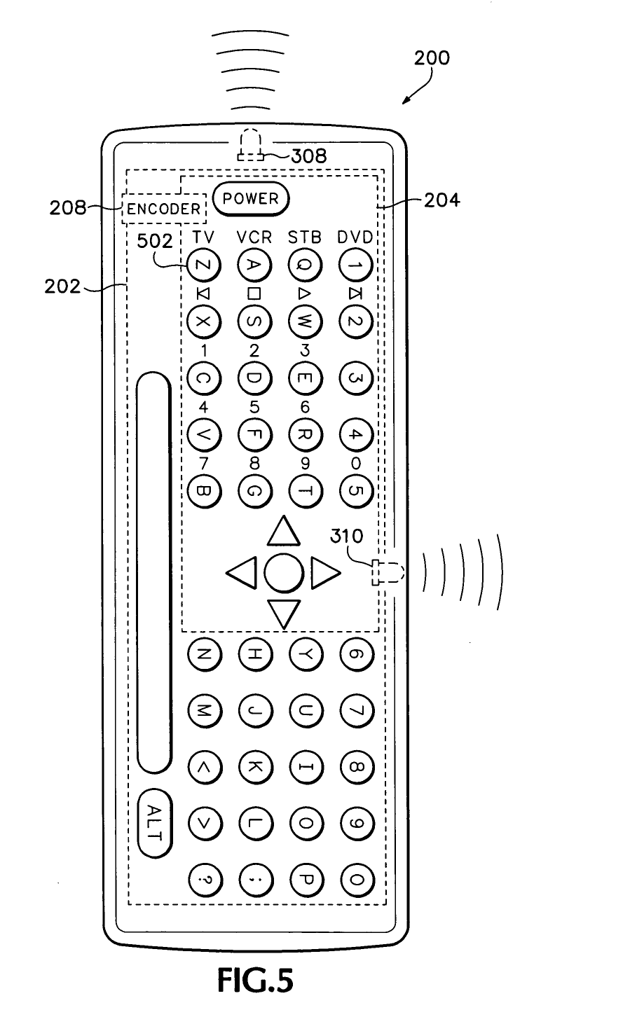

FIG. 5 is a diagram of an alternative remote control embodiment 200. Referring to FIGS. 1, 5, and 7, the remote 200 includes the plurality of control keys 204 overlaid with the plurality of alphanumeric keys 202. The plurality of control keys 204 is aligned in the first direction, e.g., in a longitudinal direction. The plurality of alphanumeric keys 202 is aligned in a second direction, e.g., substantially orthogonal to the first longitudinal direction. That is, keys on the remote control might have a dual function. For example, key 502 might be a TV control key when the remote 200 is oriented in the first direction and the letter Z when the remote 200 is oriented in the second direction. As with previous embodiments, the control codes 254 might be the same or different than the alphanumeric codes 252. The television 100 might be capable of distinguishing a same code as being an alphanumeric code 252 by identifying the second transmitting device 310.

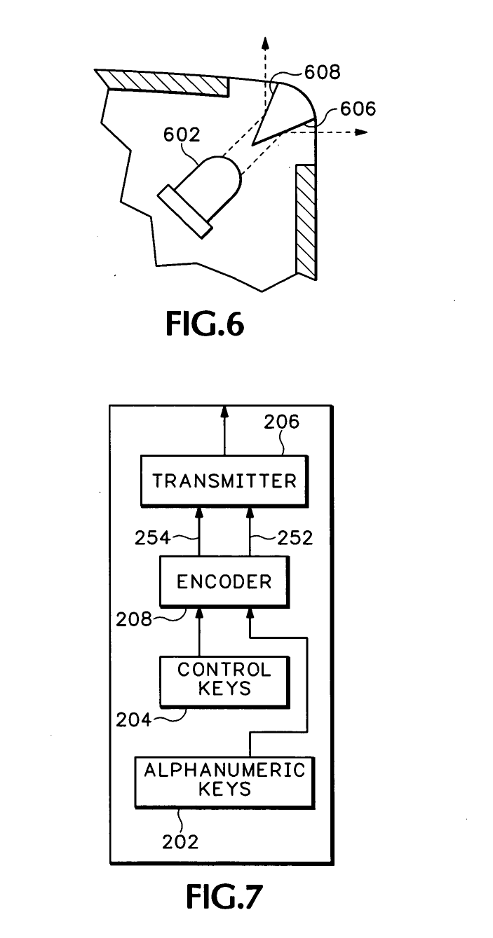

FIG. 6 is a diagram of a transmitter 206 embodiment. In previously discussed embodiments, the transmitter 206 might comprise two transmitting devices, e.g., devices 308 and 310 shown in FIGS. 3A-5. A single transmitting device 602 together with at least two mirrors 604 and 606 take the place of the transmitting devices 308 and 310. The mirrors 604 and 606 split the signal transmitted from the transmitter 602 in at least two directions that depend on the orientation of the mirrors 606 and 608. In FIG. 6, the mirrors 606 and 608 are oriented such that the signal transmitted from the device 602 is split into two orthogonal signals.

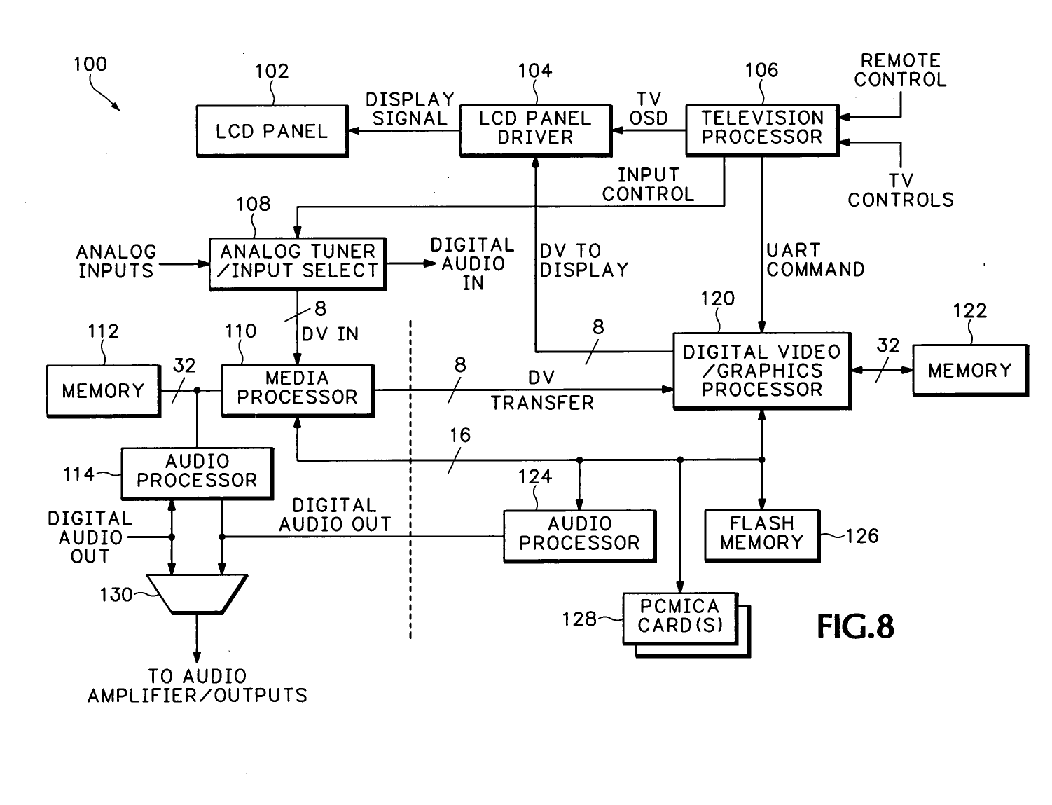

FIG. 8 is a block diagram of a television capable of operating according to some embodiments of the present invention. The television 100 includes a panel 102 having a fixed pixel structure, e.g., liquid crystal displays (LCDs), plasma displays, and the like. For simplicity, we refer to panel 102 as an LCD panel. Referring to FIG. 8, television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120. A person of reasonable skill in the art should recognize that the LCD panel driver 104 might accept a primary digital video signal in formats other than CCIR656 and still come within the scope of the present invention.

A television processor 106 provides basic control functions and viewer input interfaces for television 100. Television processor 106 receives viewer commands, both from buttons located on the television itself (TV controls) and from a handheld remote control (FIGS. 1-7) through the Remote Control Port. The Remote Control Port might accept input from the remote control in a variety of manners including infrared and radio waves as are well known in the art.

Based on the viewer commands, television processor 106 controls an analog tuner/input select section 108, and also supplies viewer inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or Red Green Blue (RGB) component video inputs, although various embodiments may not accept each of these signal types or may accept signals in other formats (such as PAL). The selected video input is converted to a digital data stream, DV In, in CCIR656 format (or other formats) and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 10 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 10 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

1. A system, comprising:
a television; and
a remote control to control the television, the remote control including an alphanumeric keypad.

2. The system of claim 1 where the alphanumeric keypad includes a plurality of numeric, alphabetic, punctuation, space, and special character keys.

3. The system of claim 1 where the alphanumeric keypad is a QWERTY type keypad.

4. The system of claim 1 where the remote control comprises an encoder to encode each key of the alphanumeric keypad with a corresponding keypad code.

5. The system of claim 4 where the remote control comprises a transmitter to transmit any of the keypad codes to the television.

6. The system of claim 4 where the transmitter transmits any of the keypad codes to the television using infrared technology.

7. The system of claim 4 where the transmitter transmits any of the keypad codes to the television using radio waves.

8. The system of claim 5
where the transmitter includes first and second transmitting devices;
where the first transmitting device transmits any of the keypad codes to the television; and
where the second transmitting device transmits control codes associated with other keys on the remote control.

9. The system of claim 8 where the first and second transmitting devices are positioned on the remote control to transmit in first and second directions, respectively.

10. The system of claim 9 where the first direction is substantially orthogonal to the second direction.

11. The system of claim 8 where the first and second transmitting devices are infrared transmitting devices.

12. The system of claim 8 where the first and second transmitting devices are first and second directional antennas, respectively.

13. The system of claim 12 where the first and second directional antennas are oriented substantially orthogonal to each other.

14. The system of claim 12
where the first directional antenna transmits using a first frequency carrier signal; and
where the second directional antenna transmits using a second frequency carrier signal, the first frequency carrier signal being different than the second frequency carrier signal.

15. The system of claim 12 where the first and second directional antennas transmit unique keypad codes for associated keys using a same frequency carrier signal.

16. The system of claim 1
where the remote control includes a television control keypad; and
where the alphanumeric keypad is located along with the television control keypad on the remote control in a longitudinal direction.

17. The system of claim 1
where the remote control includes a television control keypad positioned on a top portion movably coupled to a body portion; and
where the alphanumeric keypad is positioned on the body portion such that when a viewer flips the top portion, the alphanumeric keypad is exposed.

18. The system of claim 1
where the remote control includes a television control keypad on a same surface as the alphanumeric keypad, the television control keypad being oriented in a longitudinal direction and the alphanumeric keypad being oriented in a direction transverse to the longitudinal direction.

19. The system of claim 1 where the alphanumeric keypad is overlaid with a control keypad, the alphanumeric keypad being aligned in a first direction and the control keypad being aligned in a second direction.

20. The system of claim 1
where the remote control includes a television control keypad;
where the alphanumeric keypad is located on a top side; and
where the control keypad is located on a bottom side.

21. A remote control to control a television, comprising:
a plurality of control keys; and
a plurality of alphanumeric keys.

22. The remote control of claim 21 where the plurality of alphanumeric keys include alphabetic, numeric, punctuation, space, and special character keys.

23. The remote control of claim 21 where the plurality of alphanumeric keys are arranged as in a QWERTY keyboard.

24. The remote control of claim 21
where the remote control has a top portion and lower portion;
where the control keys are positioned in the first direction on the top portion; and
where the alphanumeric keys are position in a second direction on the lower portion.

25. The remote control of claim 21
where the plurality of control keys are aligned in a first direction; and
where the plurality of alphanumeric keys are aligned in a second direction, the first direction being substantially orthogonal to the second direction.

26. The remote control of claim 25
where the remote control includes:
a body; and
a top movably coupled to the body;
where the control keys are located on the top; and
where the alphanumeric keys are located on the body.

27. The remote control of claim 25
where remote control includes first and second portions;
where the control keys are located on the first portion in the first direction; and
where the alphanumeric keys are located on the second portion in the second direction.

28. The remote control of claim 21 comprising an encoder to encode the control and alphanumeric keys into control and alphanumeric codes, respectively.

29. The remote control of claim 21 comprising a transmitter to transmit control and alphanumeric codes associated with the control and alphanumeric keys.

30. The remote control of claim 29 where the transmitter includes first and second transmitting devices, the first transmitting device transmitting in a first direction and the second transmitting device transmitting in a second direction, the first direction being substantially orthogonal to the second direction.

31. The remote control of claim 30
where the first transmitting device transmits any of the control codes associated with the control keys; and
where the second transmitting device transmits any of the alphanumeric codes associated with the alphanumeric keys.

32. The remote control of claim 30 where the first and second transmitting devices are infrared transmitting devices.

33. The remote control of claim 30 where the first and second transmitting devices are first and second directional antennas.

34. The remote control of claim 33
where the first directional antenna transmits using a first frequency carrier signal; and
where the second directional antenna transmits using a second frequency carrier signal.

35. The remote control of claim 33 where the first and second directional antennas transmit unique control and alphanumeric codes associated with each control and alphanumeric key using a same frequency carrier signal.

36. The remote control of claim 29 where the transmitter includes:
a transmitting device; and
at least two mirrors arranged to split a signal from the transmitting device in first and second directions.

37. The remote control of claim 29 where the transmitter includes a multidirectional antenna.

38. A method of controlling a television with a remote control, comprising:
encoding a plurality of alphanumeric keys on the remote control with a corresponding plurality of alphanumeric codes; and
transmitting any of the plurality of alphanumeric codes to the television.

39. The method of claim 38 comprising
transmitting any of the plurality of alphanumeric codes when the remote control is oriented in a first direction.

40. The method of claim 39 comprising
encoding a plurality of control keys on the remote control with a corresponding plurality of control codes; and
transmitting any of the plurality of control codes to the television.

41. The method of claim 40 comprising
transmitting any of the plurality of control codes when the remote control is oriented in a second direction.

42. The method of claim 38 comprising
positioning the alphanumeric keys on a bottom portion of the remote control; and
positioning the control keys on a top portion of the remote control.

43. The method of claim 42 where transmitting includes
transmitting the alphanumeric codes and the control codes using a transmitting device oriented in a first direction.

44. The method of claim 38 comprising
positioning the alphanumeric keys on a body of the remote control; and
positioning the control keys on a top portion of the remote control movably coupled to the body such that when the top portion is flipped up, the alphanumeric keys are exposed.

45. The method of claim 44 where transmitting includes
transmitting the alphanumeric codes when the remote control is oriented in a first direction; and
transmitting the control codes when the remote control is oriented in a second direction.

46. The method of claim 45
where transmitting the alphanumeric codes includes using a first transmitting device; and
where transmitting the control codes includes using a second transmitting device.

47. The method of claim 46 where the first and second transmitting devices are infrared devices.

48. The method of claim 46 where the first and second transmitting devices are first and second directional antennas.

49. The method of claim 44 where transmitting includes
transmitting the alphanumeric codes when the top portion is flipped up.

50. The method of claim 38 comprising
positioning the alphanumeric keys on a first portion of the remote control aligned in a first direction; and
positioning the control keys on a second portion of the remote control aligned in a second direction.

51. The method of claim 50 where transmitting includes
transmitting the alphanumeric codes when the remote control is aligned in the first direction; and
transmitting the control codes when the remote control is aligned in the second direction.

52. The method of claim 38 comprising
overlaying the alphanumeric keys with the control keys, the alphanumeric keys being aligned in a first direction and the control keys being aligned in a second direction;
transmitting any of the alphanumeric codes using a first transmitting device when the remote control is oriented in the first direction; and
transmitting any of the control codes using a second transmitting device when the remote control is oriented in the second direction.
